(19) United States
(12) Patent Application Publication
(10) Pub. No.: US 2015/0046357 A1
(43) Pub. Date: Feb. 12, 2015

(54) SYSTEMS AND METHODS FOR EVALUATING JOB CANDIDATES

(71) Applicant: Mattersight Corporation, Chicago, IL (US)

(72) Inventors: Christopher DANSON, Austin, TX (US); Brittney Lynn Mcingvale, Chicago, IL (US); Alain Stephan, Glenview, IL (US); Tomasz Stadnik, Chicago, IL (US); Samantha Shruti Desikan, Oak Park, IL (US); Roger Warford, Hoschton, GA (US)

(21) Appl. No.: 13/963,646

(22) Filed: Aug. 9, 2013

(51) Int. Cl. G06Q 10/10

(52) U.S. Cl. CPC G06Q 10/1053
USPC 705/321

(57) ABSTRACT

The methods, apparatus, and systems described herein facilitate making hiring decisions. The methods include identifying keywords associated with one or more categories relevant to a job position, receiving the candidate's answers to interview questions, reviewing the answers for the identified keywords, and outputting a score for the one or more categories based on a density of the keywords in the answers.

### TECHNICAL FIELD

The present disclosure generally relates to methods, apparatus, and systems for evaluating job candidates, and more particularly to applying linguistic analysis to the text of answers given by the job candidate during an interview.

### BACKGROUND OF THE DISCLOSURE

The hiring and assessment of job candidates is not easy. A commonly-used approach to matching job candidates to open positions involves the identification of a candidate's skills so as to match that candidate with an open position requiring those skills. Although this is a good way to find people who have the general qualifications for a particular job, there are a myriad of other characteristics and factors that are not considered when using this method. Another common approach to matching job candidates to open positions involves the use of directed questions to evaluate the job candidate. The results of the evaluation are used to compare the candidate to the open position and identify a match, if any. Again, although this approach may succeed in identifying certain similarities between a job candidate and a job, there are many other factors that should be taken into consideration when hiring the right person for an open position.

Furthermore, the conventional interview process consists of setting up and carrying out various interviews between selected interviewers and the job candidates. Subsequently, interviewers are asked for feedback on the job candidates. The conventional interview process, however, has its drawbacks. Problems with the conventional interview process include a lack of preparation by the interviewers, which can result in anxiety or concern in the job candidate being interviewed, personal bias of the interviewer, overemphasis on irrelevant criteria, as well as a misuse of time since the interview is not productive. Additionally, the feedback provided by interviewers during the conventional interview process often revolves around the interviewer's personal comfort or personal style, not the attributes and skills that are most pertinent to the job. This results in hiring that is often not based on facts and the needs of the employer, but rather, subjective preferences and conjecture. Moreover, the conventional interview process often involves a group meeting of interviewers wherein the job candidates are discussed. Meetings of this type are often dominated by the opinions of the highest ranking participant, instead of a true exchange of the most pertinent feedback on the job candidates.

Improvements in evaluating job candidates are therefore needed.

### SUMMARY

The present disclosure seeks to analyze the text of answers given during an interview to evaluate the candidate and predict the candidate's performance in the position. Before the interview takes place, keywords associated with one or more categories relevant or related to a job position are identified. For example, words that indicate how motivated or enthusiastic a candidate is, or how knowledgeable about a job requiring specified technical expertise the candidate is, may be identified. During the interview, the candidate is asked a series of questions. The candidate's answers are received, recorded, and analyzed. The answers are analyzed to determine how many times the identified keywords appear in the answers. A score that is based on the density of the keywords can then be output and used by a recruiter or employer.

The systems, apparatus, and methods disclosed herein may be used to more efficiently evaluate job candidates for an available position. The present disclosure describes how to score and prioritize candidates.

In a first aspect, the invention encompasses a system for evaluating a job candidate that includes a node comprising a processor and a computer readable medium operably coupled thereto, the computer readable medium comprising a plurality of instructions stored in association therewith that are accessible to, and executable by, the processor, where the plurality of instructions includes, instructions, that when executed, receive a job candidate's verbal answers to a plurality of interview questions; instructions, that when executed, record the answers; instructions, that when executed, apply a linguistic algorithm to text of the answers; wherein the linguistic algorithm is trained to find identified keywords; and instructions, that when executed, output a score for the job candidate based on a density of the identified keywords in the answers.

In a second aspect, the invention encompasses a method of evaluating a job candidate that includes identifying keywords associated with one or more categories relevant to a job position, receiving the candidate's answers to interview questions, reviewing the answers for the identified keywords, and outputting a score for the one or more categories based on a density of the identified keywords in the analyzed answers.

In a third aspect, the invention encompasses a computer readable medium comprising a plurality of instructions that includes instructions, that when executed, receive a job candidate's verbal answers to interview questions; instructions, that when executed, score the job candidate's answers for a plurality of categories using at least one linguistic algorithm; instructions, that when executed, aggregate the score for each category into an overall interview score; and instructions, that when executed, display the overall interview score.

In a fourth aspect, the invention encompasses an apparatus for evaluating job candidates that includes a recording module configured to receive and record a plurality of answers from job candidates, a scoring module configured to receive identified keywords associated with predefined criteria for a position, apply an algorithm trained to find the keywords and the number of times the keywords are used in the answers, and score the answers for each job candidate using the trained algorithm; and a display module configured to output a score for each job candidate.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a block diagram of an embodiment of a system for evaluating a job candidate according to various aspects of the present disclosure.

FIG. 2 is a flowchart illustrating a preferred method of evaluating a job candidate according to aspects of the present disclosure.

FIG. 3 is a block diagram of a computer system suitable for implementing one or more components in FIG. 1 according to an embodiment of the present disclosure.

### DETAILED DESCRIPTION OF THE PREFERRED EMBODIMENTS

The present disclosure advantageously provides for methods of evaluating a job candidate's strengths, weaknesses, and personality for a particular job position. The methods score and prioritize interviews by applying linguistic analysis to the transcripts of the answers by each candidate. These methods typically include identifying keywords associated with one or more categories relevant to a job position, receiving a job candidate's answers to a set of interview questions, reviewing the answers for the keywords, and outputting a score for the one or more categories based on a density of the keywords in the answers. Optionally, the analysis may involve reviewing answers to ensure they exclude or minimize certain keywords, for example, foul language or overuse of meaningless business jargon.

Systems and apparatuses for carrying out these methods are also part of the present disclosure. An exemplary system to evaluate a job candidate includes, for example, a node including a processor and a computer readable medium operably coupled thereto, the computer readable medium comprising a plurality of instructions stored in association therewith that are accessible to, and executable by, the processor, where the plurality of instructions includes instructions, that when executed, receive a job candidate's verbal answers to interview questions, record the answers, apply a linguistic algorithm to text of the answers, and output a score for the job candidate based on density of identified keywords in the answers. The algorithm predicts how well or how poorly the candidate will perform in a particular job position.

For the purposes of promoting an understanding of the principles of the present disclosure, reference will now be made to the embodiments illustrated in the drawings, and specific language will be used to describe the same. It is nevertheless understood that no limitation to the scope of the disclosure is intended. Any alterations and further modifications to the described devices, systems, and methods, and any further application of the principles of the present disclosure are fully contemplated and included within the present disclosure as would normally occur to one of ordinary skill in the art to which the disclosure relates. In particular, it is fully contemplated that the features, components, and/or steps described with respect to one embodiment may be combined with the features, components, and/or steps described with respect to other embodiments of the present disclosure. For the sake of brevity, however, the numerous iterations of these combinations will not be described separately.

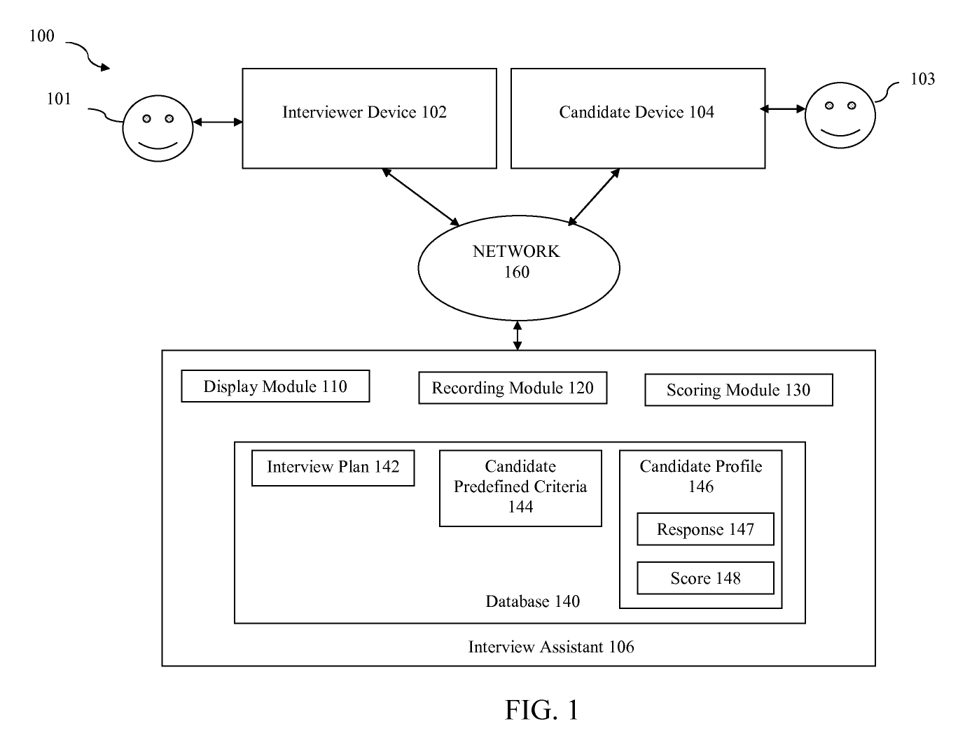

FIG. 1 depicts a schematic block diagram of a system 100 in accordance with one or more embodiments of the present disclosure. The system 100 includes interviewer device 102 that is used by a recruiter or interviewer 101, candidate device 104 that is used by a job candidate 102, and interview assistant 106 in communication over a network 160. Although only one recruiter and one candidate are shown in FIG. 1, it should be understood that multiple interviewers or multiple candidates may be included simultaneously or concurrently in the system 100, or that one interviewer can interface with multiple candidates at a time or in sequence. As shown in FIG. 1, the interview assistant 106 includes display module 110, recording module 120, scoring module 130, and database 140. In addition, database 140 further includes interview plan 142, candidate predefined screening criteria 144, and candidate profile 146. In one or more embodiments, the interview plan 142 or the candidate screening criteria 144 may be custom defined based on predefined requirements, such as keywords for candidates to use that predict success or fit for a particular job position. In various examples, interviewer device 102 and candidate device 104 may be implemented by any system suitable for videoconference communication, such as a videoconference camera, wireless telephone (e.g., cellular or mobile phone), a tablet, a personal digital assistant (PDA), a personal computer, a notebook computer, and/or various other generally known types of wired and/or wireless computing devices. In some embodiments, a telephone or other oral communication-only equipment can be used that are sufficient to collect the verbal answers from the job candidate. The systems need not be symmetric, and either the interviewer or candidate may have a camera in their device 102, 104 while the other has access only to verbal communication equipment in their device 102, 104, but in one embodiment, they are symmetric. In another embodiment, the interviewer device 102 and candidate device 104 include videoconference capability including video and audio signals.

The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet. Any suitable network to connect the interviewer and candidate may be used.

The interviewer device 102 and the candidate device 104, in various embodiments, may be implemented using any appropriate combination of hardware and/or software configured for wired and/or wireless communication over the network 160. The interviewer device 102, in one embodiment, may be utilized by the recruiter 101 to interact with the interview assistant 106 over the network 160. Similarly, the candidate device 104 may be utilized by the candidate 103 to interact with the interview assistant 106 over the network 160.

The interviewer device 102 and the candidate device 104, in one embodiment, includes a user interface application (not shown), which may be used by the recruiter 101 and/or the candidate 103 to conduct transactions with the interview assistant 106 over the network 160.

In one implementation, the user interface application comprises a software program, such as a graphical user interface (GUI), executable by a processor that is configured to interface and communicate with the interview assistant 106 via the network 160. In another implementation, the user interface application comprises a browser module that provides a network interface to browse information available over the network 160. For example, the user interface application may be implemented, in part, as a web browser to view information available over the network 160.

In one or more embodiments, the recruiter 101 is a person seeking to fill a position using an interview based on certain criteria specific to that position. The person may be a business owner (for profit or non-profit), an individual, an agent acting on behalf of a business or an individual, or other types of people having a need to fill a position (e.g., a couple interviewing to fill a nanny or personal chef position, a Board of Directors or subcommittee thereof interviewing for a CEO or a Chairman, etc.). A recruiting decision may be made as a result of the interview to establish a relationship (e.g., a business relationship, a contractual relationship, a social relationship, or other types of relationships) between a person filling the position and the recruiter 101 or the business or individual for whom the recruiter 101 is acting as an agent. The position may be an employee position, management position, a partner position, a service provider position, consultant position, contract position, or other types of business or service positions. In one or more embodiments, the candidate 103 is a person interested in filling the position sought to be filled by the recruiter 101. In another embodiment, the recruiter 101 could be a person seeking a life partner or suitable dating candidate, or someone recruiting on behalf of that person. Thus, the candidate 103 in this embodiment is seeking an opportunity where the “job position” is actually that of a date or a potential life partner, rather than a more traditional job involving compensation, and keywords are selected accordingly.

In one or more embodiments, the interview assistant 106 may be configured as a stand-alone workstation (e.g., a kiosk requiring personal appearance of the candidate) or a networked system (e.g., an Internet web-based system accessible by any candidate worldwide) for conducting interviews with the candidate 103. In various embodiments, the interview assistant 106 is configured to receive a variety of communications, such as telephone calls, facsimile transmissions, e-mails, web interactions, voice over IP (“VoIP”) and video. In some embodiments, the recruiter 101 does not need to be present for the interview to take place. The interview assistant 106 may be pre-programmed with appropriate questions to ask the candidate 103. In one embodiment, the candidate is remote in location from the interviewer and/or the interview assistant. In this embodiment, the candidate accesses the system and apparatus of this disclosure through their own hardware device as discussed herein, such as a videophone or computer, or by visiting a remote interview site having such equipment, which remote interview sites could be centrally located or temporarily set up in or near one or more population centers having potential candidates.

As shown in FIG. 1, the display module 110 is used to present an electronic interview (e.g., questions) to the candidate 103. In some embodiments, the display module 110 also presents the results of the interview to the recruiter 101. The recording module 120 is used to capture the response of the candidate 103 undergoing the interview, including the verbal answers. The scoring module 130 is used to analyze and rate the response of the candidate 103 in real-time during the interview or off-line subsequent to the interview. The database 140 is used to store various information or data required by the display module 110, recording module 120, and scoring module 130. In one embodiment not depicted, a candidate can answer questions in writing, e.g., by email, chat, or instant message/MMS/SMS through typing responses to questions emailed serially. This type of written-only interview may be less accurate, however, because non-verbal answers may be more susceptible to interference should a candidate use other resources like a friend or text from an internet search in answering such questions instead of using their own words. Moreover, candidates may be distracted when not focused solely on the interview, as is more likely when being forced to interact spontaneously during an interview with a job interviewer through the network 160. This type of written interview could either hurt or help their opportunities for these and other reasons, but in either case it might not give as accurate an analysis of the candidates themselves. Nevertheless, it could be suitable for certain positions, e.g., a social media coordinator, or the like.

In one or more embodiments, candidate predefined criteria 144 is used to identify a candidate having desired qualifications, such as knowledge, skill, ability, character, aptitude, manner, conduct, ethics, or other characteristics desired for the particular job position to be collected. The electronic interview presented to the candidate 103 by the display module 110 is directed according to the interview plan 142 that is based on the predefined criteria 144. These criteria 144 are in various embodiments selected for the specific job position, or group of positions. For example, all applicants with expertise in computers might be pursued for staffing an IT company or entire IT department, or a particular position of, e.g., network engineer or Tier II support or the like, might be specifically desired to be filled. The criteria 144 are preferably selected to target keywords correlative with expertise in that field needed for the specific position (or group of positions in general). Generally, the term “position” when used herein could refer to either a specific position or a group of positions that need to be filled or to pre-screen candidates for positions that may need to be filled.

The interview plan 142 may include one or more sessions, each associated with scoring criteria. Each session may include a pre-selected number of questions sufficient to obtain useful information, for example, at least: six to twenty questions, eight to sixteen questions, ten questions, twelve questions, or fourteen questions. These interview sessions and associated scoring criteria are preferably defined to assess various qualifications of the candidate 103 such as knowledge, skill, ability, character, aptitude, manner, conduct, ethics, or other characteristics for a position without a face to face interview process and real-time personal judgment of the recruiter 101. It should be understood that, by one or more sessions could mean that one interview may take multiple sessions due to lack of time or extensive answers, or it could refer to a sequence of interviews each pursuing different questions under a multi-part interview plan 142. As an example of the latter, an initial interview might pursue candidates suitable for a group of positions, and those candidates scoring above a threshold or meeting one or more criteria might have a second interview session whereby the criteria have been set to evaluate suitability for a specific position within that group of positions.

During the interview, the display module 110 may present interview situations, such as questions or spontaneous scenarios for gauging a corresponding response 147 from the candidate 103. These questions or spontaneous scenarios may be presented to the candidate 103 as text-based descriptions, streaming media (e.g., audio, video, etc.) presentations, or other environmental stimulus (e.g., temperature, pressure, or other sensory stimulus) during an interview session. In one or more embodiments, the display module 110 may present a pre-defined sequence of interview sessions in a narrative mode. In other embodiments, the display module 110 may deviate from the pre-defined sequence based on real-time feedback from the scoring module 130 and select a substitute session in an interactive mode.

In various embodiments, the recording module 120 captures any response 147 from the candidate 103 using various input devices such as text input device (e.g., computer keyboard), pointing device (e.g., computer mouse), audio device (e.g., microphone), video device (e.g., camera), etc. In some embodiments, the recording module 120 records only the response and not the question that was asked or any other dialog or instructions provided by the interviewer. That is, in these embodiments, the whole interview is not recorded but only the answers by the candidate 103.

During an interview session, the corresponding response 147 may include composite information or data captured from one or more of these various input devices. While text input and pointing devices are capable of gathering responses consciously provided by the candidate 103, audio and video devices may supplement the conscious responses with additional pertinent information regarding the behavior of the candidate 103 when presented with the interview questions or spontaneous scenarios. For example, video of the candidate 103 can be analyzed to determine appearance (e.g., grooming, quality of clothes, etc.), confidence (e.g., nervous movements, eye contact, frequency of blinking, etc.), and use of gestures. Voice signal analysis can also be performed on audio portions of the interview to detect emotions by analyzing pitch, tone, and frequency of words. Combinations of audio/video devices may be used to capture composite response (e.g., including text, audio, video, or other pertinent data) that provides information missing in traditional virtual interviews conducted without face-to-face meeting and real-time personal judgment of the recruiter 101. Thus, in various embodiments, video conferencing or capture is used and includes audio. It should be understood that, in all uses of the present apparatus, system, and methods, the interview plan may need to include an initial question confirming the candidate's consent to have the interview answers recorded, as legal requirements in various jurisdictions may require the consent of both parties to properly make recordings of this nature.

In various embodiments, the scoring module 130 analyzes any response 147 captured by the recording module 120 during an interview session by applying at least one linguistic algorithm to the each of the answers. A linguistic algorithm(s) is typically created by linguistic analysts and such algorithm(s) are typically trained using previously analyzed candidate answers. Answers to different types of questions may have a different algorithm applied if desired, or if found useful over time in correlating job success with answers. In one embodiment, the analyst(s) can review candidate responses and manually label keywords or terms that are relevant to a category. The algorithm is trained to check for those keywords and the number of times they are used in the answers. A more sophisticated algorithm may be used that additionally checks for use of the keywords in context, i.e., to prevent a candidate from simply rattling off a cluster of buzzwords yet still being found suitable for a position. Use of the algorithm(s) is based on the assumption that good candidates will use certain terms that poor candidates will not use, and vice versa. In some embodiments, the algorithm(s) are calibrated to determine what a good candidate versus a poor candidate is. One master algorithm containing many specific algorithms may be used.

In another embodiment, previous candidates that have been successful in their position are interviewed (or a prior recording of their interview located and used) to understand how they describe themselves, their experiences, and their skills. Machine learning technology then translates these keywords, terms, and phrases into one or more algorithms trained to recognize these attributes in other candidate interviews. A human analyst further evaluates such algorithms and keywords in some embodiments to help ensure accuracy and suitability.

Each algorithm is trained with known inputs, i.e., the previously analyzed candidate answers described above, and learns these patterns through one or more statistical methods. The algorithm(s) can then properly classify new input based on the inputs it has received and processed during training. The algorithm should be able to perform accurately on new, unseen examples after having trained on a learning data set. The larger the comparable data set, the higher the accuracy the algorithm is likely to achieve. In various embodiments, the algorithm(s) are calibrated, customized, and updated according to different candidate expectations, or different expectations about a particular candidate or candidate pool. The algorithm modification may be done with a particular position in mind, as well, in some embodiments.

Algorithm techniques can be applied to interviews captured through voice calls, voice recordings, as well as interview transcripts. Using linguistic profiling, conversations can be algorithmically measured against requirements that relate to the environment, culture, interpersonal skills, and aptitudes of the position.

In one embodiment, the algorithm(s) leverage statistical and linguistic approaches and aim to take into account the many dimensions or categories of a candidate including, but not limited to engagement, motivation, distress, and personality type. The term “engagement” is meant herein to refer to the level of enthusiasm and dedication a worker feels towards his or her job. An engaged employee cares about their work and about the performance of the company, and conversely, feels that their efforts make a difference. Engaged employees are more likely to be productive and higher performing. The term “motivation” is meant herein to refer to the factors that stimulate desire and energy in people to be continually interested and committed to a job. Motivated employees look for better ways to do a job, care about their customers, take pride in their work, and are more productive. The term “distress” is meant herein to refer to dissatisfaction, anxiety, sorrow, anger, or a combination thereof. Distressed employees are generally not desired in the workplace, and can cause problems. Employees showing signs of distress may have mental health problems and may even be a safety risk to themselves and their co-workers. In each case, it should be understood that these are tendencies, not absolutes, and that not all the characteristics may apply to a given candidate. For example, a motivated candidate may try to be more productive or efficient, but may not care about the customers. A suitable algorithm will seek to factor the various sub-characteristics into the final score. Finally, by “personality type” is meant herein, for example, Thoughts, Opinions, Reactions, and Emotions, although these may vary in type and number depending on the personality model selected.

In some embodiments, the responses are subjected to a linguistic-based psychological behavioral model to assess the personality of the candidate. For example, such a behavioral model may be applied to the transcription of a telephone call, instant message conversation, or email thread, between a candidate and a recruiter. In one embodiment, the responses are mined for behavioral signifiers associated with a linguistic-based psychological behavioral model. In particular, the scoring module 130 searches for and identifies text-based keywords (i.e., behavioral signifiers) relevant to a predetermined psychological behavioral model.

It is well known that certain psychological behavioral models have been developed as tools, and any such behavioral model available to those of ordinary skill in the art will be suitable for use in connection with the disclosure. These models are used to attempt to evaluate and understand how and/or why one person or a group of people interacts with another person or group of people. One example is the Big Five inventory model (© 2000) by UC Berkeley psychologist Oliver D. John, Ph.D. Another is the Process Communication Model™ developed by Dr. Taibi Kahler. Exemplary personality types, which will vary from model to model and can be selected as desired for a given application or across all applications, might include, for example: Thoughts, Opinions, Reactions, Emotions. These models generally presuppose that all people fall primarily into one of the enumerated basic personality types. In some cases, the models categorize each person as one of these four types (or some other number of personality types), all people have parts of each of the types within them. Each of the types may learn differently, may be motivated differently, may communicate differently, and may have a different sequence of negative behaviors in which they engage under certain circumstances, e.g., when they are in distress. Importantly, each personality type may respond positively or negatively to communications that include tones or messages commonly associated with another of the personality types. Thus, an understanding of a candidate's personality type typically offers guidance as to how the candidate will react or respond to different situations.

In some embodiments, the scoring module 130 generates real-time analysis results of the various categories discussed herein. In various embodiments, these real-time analysis results may be used as feedback to the display module 110 in the interactive mode. Thus, an interview plan 142 may include an alternative track of questions to pursue depending on a candidate's answer to one or more prior questions.

Ultimately, these real-time analysis results are compiled and evaluated to generate a score 148 for each of the answers in each category tested. The scoring module 130 takes the text of recorded answers and applies one or more linguistic algorithms to the text to create evaluations of the candidates. Using linguistic technology has been found to provide a superior evaluation of strengths and preferences of the candidates for a particular position. Data is collected and analyzed by an algorithm, thus eliminating the human subjectivity component.

In addition, the scoring module 130 organizes the interview responses and scores into a candidate profile 146. In one or more embodiments, the scoring module 130 analyzes candidate answers to text-based multiple choice questions against an answer template. In some embodiments, the scoring module 130 may perform voice stress analysis, facial stress analysis, or other suitable audio/video feature extraction and analysis techniques to analyze the captured audio/video responses for generating the analysis results, or to corroborate the text-based analysis, or both. The scoring module 130 may perform these analyses automatically, in real-time, or batch mode, or alternatively as appropriate, according to the interview plan 142 or network 160 availability without human activation, for example, from the recruiter 101.

In one or more embodiments, the candidate profile 146 of the candidate 103 may be compared to the predefined criteria 144 to identify whether the candidate 103 is acceptable for the position. For example, various interview sessions may be defined with varying focuses for assessing different attributes of the candidate 103 on which the predefined criteria 144 may have different emphases or priorities based on the characteristics of the position that the recruiter 101 is seeking to fill. In one or more embodiments, the candidate profile 146 may include a list of scores (e.g., score 148) rated by the scoring module 130 based on the interview responses (e.g., response 147) captured by the recording module 120 from the candidate 103 during the interview. The candidate predefined criteria 144 may include a list of minimum, maximum, or range of scores each corresponding to an interview session from the interview plan 142 to which the candidate profile of an acceptable candidate must conform. In another embodiment, the comparison is against all the other analyses to consider whether the candidate 103 is the best of those interviewed for the position. In this embodiment, human intervention may be preferred to conduct further in-person interviews for one or more of the candidates 103 based on scores, such as by selecting individuals or by determining there are sufficient resources (e.g., time, money, etc.) to bring in X number of top-scoring candidates for in-person interviews.

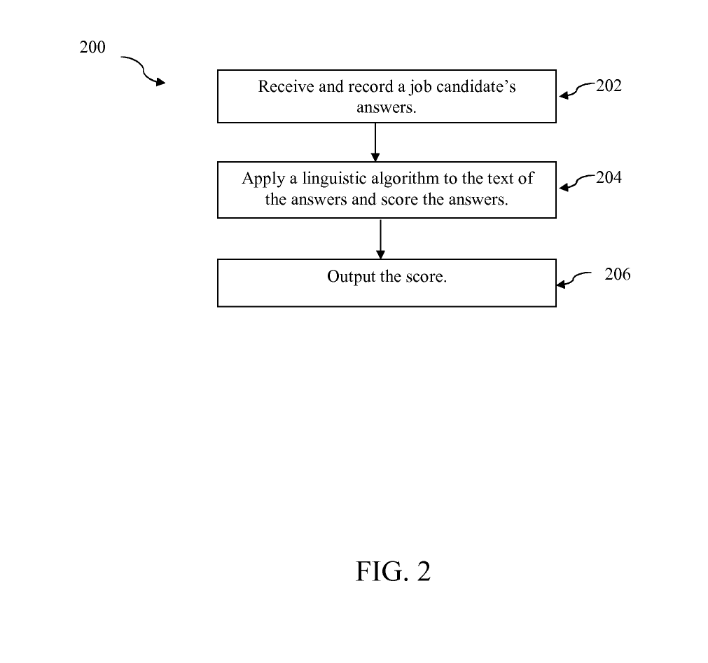

An exemplary method 200 of evaluating a job candidate according to the disclosure will now be described with respect to FIG. 2. At step 202, the recording module 120 receives a candidate's answers to various interview questions presented by the interview assistant 106 and records them. The answers may be received in any form of electronic communication, including text based (email, text, web interaction) or recorded verbal (telephonic) responses or video based responses. In various embodiments, the non-text answers are converted to text before further processing.

At step 204, at least one linguistic algorithm is applied to the text of each answer and a score is generated. The algorithm looks for specific terms, keywords and phrases (i.e., groups of keywords) that indicate a relevant category (e.g., engagement, motivation, distress, and specific personality type) and the density of those terms in the answer. For example, terms indicative of engagement include “enthusiastic,” “passion,” “interest,” “eager,” etc.; terms indicative of motivation include “improve,” “success,” “goals,” “potential,” “achieve,” etc.; and terms indicative of distress include swear or curse words, “upset,” “dissatisfied,” “unfulfilled,” “negative,” etc. To determine personality type, keywords are analyzed. For example, reactions-type personalities use emotional words, opinions-types use opinion words, emotions-types use reflection words, reactions-types use reaction words.

In various embodiments, these terms, phrases, or keywords are stored in a library or libraries that are accessed by the scoring module 130. The library may separate the keywords, terms, and phrases into different categories (e.g., engagement, motivation, distress, personality type, etc.). Keywords are the words previously determined to indicate the specific characteristic in the answer. Each keyword may have respective aliases, which are essentially synonyms of keywords. Synonyms of the keywords may be identified and also stored in the library. The aliases are typically treated as interchangeable with the keywords from a scoring perspective, but in one embodiment aliases can be treated as not interchangeable if specific words, terms, or phrases are expected to be used. Aliases may also be given relative scores next to a keyword, such as an alias valued at 0.6 or 1.2 of a keyword valued at 1. Also, due to the flexibility of the methods described herein, additional words, terms, and/or phrases may be added to the library at any time, such as based on additional answers by candidates, external analysis of business terminology in current news sources, or both. For example, when it becomes apparent that another word is used frequently and is just as effective as the associated keyword, the library may be updated to include this word as an acceptable alias, or may upgrade the relative value of that alias to 1 compared to the keyword if the algorithm tracks relative values.

The answers provided by the candidate are scored by the scoring module 130. The scoring module 130 uses linguistic algorithms that are configured to detect keywords, terms, and phrases in the responses, and the responses are scored based on the number of word hits. The score can be assigned using any suitable grading scale such as a numeric scale, an alphabetical scale or other scale created to rank the candidate's performance in a certain category. In one embodiment, a numeric scale can be used having a range of values from 1 to 10, where 1 indicates a minimum score and 10 indicates a maximum score. Other ranges can be used, such as 1 to 5 or 1 to 100, or A to C or A to F, or a combination of a numerical and letter scale to indicate different characteristics or weighting to different characteristics (e.g., an A2 is twice the importance of a lower score D1); no limitation is implied by the ranges given in this description.

In one embodiment, the score for the engagement, motivation, and distress categories is a three-level scale of high, medium, or low. For example, a candidate can receive a score of high, medium, or low in engagement. In another embodiment, a finer gradation can be used with a five-, or seven-level scale for each category. Different gradation may be used between the categories, such as in a high stress job where distress can be critical, a seven-level scale may be selected to obtain a finer reference in that key category. In another embodiment, the score for the personality type is one of a, e.g., Thoughts, Opinions, Reactions, or Emotions type. Scores may be statistically modified or measured, such as by having prior scores forced into a bell curve using conventional Gaussian analysis to set scoring levels based on prior candidates and comparing the candidate's score. These scoring levels may be adjusted upwardly or downwardly from statistical levels when desired by the recruiter 101.

In certain embodiments, each answer of the candidate is scored and aggregated into an overall score for the candidate. For example, in certain embodiments, the scores for engagement, motivation, distress, and personality type are aggregated into an overall interview score. The aggregated score for each candidate can then be compared to the scores for other candidates to determine the best match for the position. Alternatively, the questions can be focused on a particular issue that falls in one or two of the categories, and the score may only be aggregated into those category scores when tabulating the total score for the candidate.

At step 206, the scores are output or displayed. While the scores output by the linguistic algorithms may be sufficient for the recruiter 101 to make a hiring decision, more information may be used to determine with increasing probability that the candidate is the right fit for the open position. This can permit a real-time or near-real-time determination by an interviewer that further questions would be meaningless if the candidate is a clear non-fit or good-fit for a position, so that an interview can be terminated before completing all the questions in an interview plan 142. By “near-real time” it is meant, for example, that a score may be updated and provided to the interviewer up to but not including the previous answer provided by the candidate. In some embodiments, other information may be combined with the scores to provide a greater degree of certainty that the candidate is the right person. Such information may include, for example, analysis of the job candidate on video and/or analysis of voice signals in the answers.

In some embodiments, the method 200 may include correlating the scores obtained to feedback on the job candidate and/or job performance. For example, after the hiring decision has been made, recruiter 101 may supply information to interview assistant 106 regarding the actual job performance of the candidate chosen. Such information may include employee evaluations, supervisor comments, performance appraisals, etc. These might be provided by a candidate from a prior job, provided directly by a candidate's prior job if authorized by the candidate, or from the recruiter's company if the candidate is an employee seeking a different position within the enterprise. The interview assistant 106 can take this information and determine if the scores accurately predicted how the candidate would perform on the job.

In another embodiment (not shown), the method 200 may provide a recommendation for a different position for which the candidate might be more suitable, concurrently, sequentially, or in lieu of providing a score relative to the specific position for which the candidate was interviewing. Occasionally, someone with specific talents does not recognize them and applies for a position that will be a misfit. The present system, apparatus, and method may also help a recruiter 101 capture and retain such talent in a position more suited to the candidate in this manner.

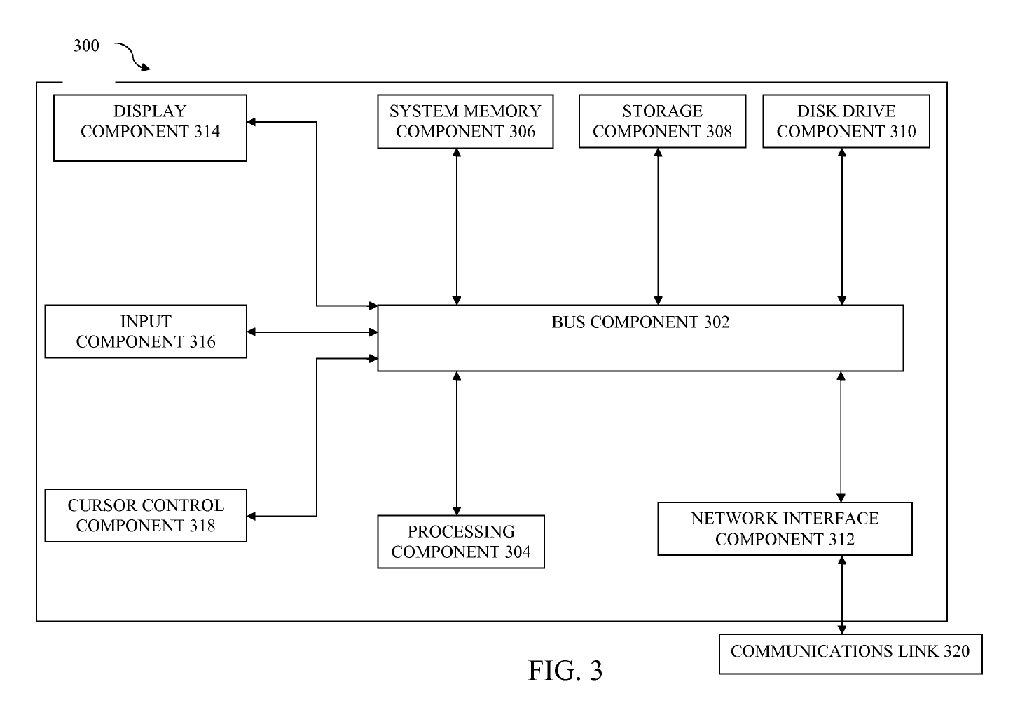

Referring now to FIG. 3, illustrated is a block diagram of an evaluation system 300 suitable for implementing embodiments of the present disclosure, including interviewer device 102, candidate device 104, and interview assistant 106 depicted in FIG. 1. System 300, such as part a computer and/or a network server, includes a bus 302 or other communication mechanism for communicating information, which interconnects subsystems and components, including one or more of a processing component 304 (e.g., processor, micro-controller, digital signal processor (DSP), etc.), a system memory component 306 (e.g., RAM), a static storage component 308 (e.g., ROM), a network interface component 312, a display component 314 (or alternatively, an interface to an external display), an input component 316 (e.g., keypad or keyboard), and a cursor control component 318 (e.g., a mouse pad).

In accordance with embodiments of the present disclosure, system 300 performs specific operations by processor 304 executing one or more sequences of one or more instructions contained in system memory component 306. Such instructions may be read into system memory component 306 from another computer readable medium, such as static storage component 308. These may include instructions to receive a job candidate's answers to interview questions, score the job candidate's answers for a plurality of categories using at least one linguistic algorithm, aggregate the score for each category into an overall interview score, display the overall interview score, etc. In other embodiments, hard-wired circuitry may be used in place of or in combination with software instructions for implementation of one or more embodiments of the disclosure.

Logic may be encoded in a computer readable medium, which may refer to any medium that participates in providing instructions to processor 304 for execution. Such a medium may take many forms, including but not limited to, non-volatile media, volatile media, and transmission media. In various implementations, volatile media includes dynamic memory, such as system memory component 306, and transmission media includes coaxial cables, copper wire, and fiber optics, including wires that comprise bus 302. Memory may be used to store visual representations of the different options for searching or auto-synchronizing. In one example, transmission media may take the form of acoustic or light waves, such as those generated during radio wave and infrared data communications. Some common forms of computer readable media include, for example, RAM, PROM, EPROM, FLASH-EPROM, any other memory chip or cartridge, carrier wave, or any other medium from which a computer is adapted to read.

In various embodiments of the disclosure, execution of instruction sequences to practice the disclosure may be performed by system 300. In various other embodiments, a plurality of systems 300 coupled by communication link 320 (e.g., network 160 of FIG. 1, LAN, WLAN, PTSN, or various other wired or wireless networks) may perform instruction sequences to practice the disclosure in coordination with one another. Computer system 300 may transmit and receive messages, data, information and instructions, including one or more programs (i.e., application code) through communication link 320 and communication interface 312. Received program code may be executed by processor 304 as received and/or stored in disk drive component 310 or some other non-volatile storage component for execution.

In view of the present disclosure, it will be appreciated that various methods, apparatuses, computer readable media, and systems have been described according to one or more embodiments for evaluating a job candidate.

Where applicable, various embodiments provided by the present disclosure may be implemented using hardware, software, or combinations of hardware and software. Also where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the spirit of the present disclosure. In addition, where applicable, it is contemplated that software components may be implemented as hardware components, and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

The foregoing outlines features of several embodiments so that a person of ordinary skill in the art may better understand the aspects of the present disclosure. Such features may be replaced by any one of numerous equivalent alternatives, only some of which are disclosed herein. One of ordinary skill in the art should appreciate that they may readily use the present disclosure as a basis for designing or modifying other processes and structures for carrying out the same purposes and/or achieving the same advantages of the embodiments introduced herein. One of ordinary skill in the art should also realize that such equivalent constructions do not depart from the spirit and scope of the present disclosure, and that they may make various changes, substitutions and alterations herein without departing from the spirit and scope of the present disclosure.

The Abstract at the end of this disclosure is provided to comply with 37 C.F.R. §1.72(b) to allow a quick determination of the nature of the technical disclosure. It is submitted with the understanding that it will not be used to interpret or limit the scope or meaning of the claims.

1. A system for evaluating a job candidate, comprising:
a node comprising a processor and a computer readable medium operably coupled thereto, the computer readable medium comprising a plurality of instructions stored in association therewith that are accessible to, and executable by, the processor, where the plurality of instructions comprises:
instructions, that when executed, present a plurality of interview questions to a job candidate;
instructions, that when executed, receive the job candidate's verbal answers to the questions;
instructions, that when executed, record the answers;
instructions, that when executed, apply a linguistic algorithm to text of the answers, wherein the linguistic algorithm is trained to find identified keywords and comprises a psychological behavioral model; and
instructions, that when executed, output a score for the job candidate based on a density of the identified keywords in the answers.

2. The system of claim 1, wherein the plurality of instructions do not include instructions to record the interview questions.

3. The system of claim 1, wherein the score is associated with one or more of engagement, motivation, distress, or personality type.

4. The system of claim 3, wherein the score for engagement, motivation, and distress is independently selected as high, medium, or low.

5. The system of claim 3, wherein the score for the personality type is an assessment that the job candidate is one of a thoughts, opinions, reactions, or emotions type.

6. The system of claim 3, further comprising instructions, that when executed, aggregate the scores for engagement, motivation, distress, and personality type into an overall interview score.

7. The system of claim 1, further comprising instructions, that when executed, analyze video of the job candidate including the verbal answers.

8. The system of claim 1, further comprising instructions, that when executed, correlate the score to direct feedback on the job candidate after being hired and/or on the job performance.

9. A method of evaluating a job candidate, which comprises:
identifying, by one or more processors, keywords associated with one or more categories relevant to a job position;
presenting, by the one or more processors, a plurality of interview questions to the job candidate;
receiving, by the one or more processors, the job candidate's answers to the interview questions;
analyzing, by the one or more processors, the answers in a text form for the identified keywords relevant to a psychological behavioral model; and
outputting, by the one or more processors, a score for the one or more categories based on a density of the identified keywords in the analyzed answers.

10. The method of claim 9, wherein the one or more categories comprise engagement, motivation, distress, or personality type.

11. The method of claim 10, wherein the score for engagement, motivation, and distress is independently selected to be high, medium, or low.

12. The method of claim 10, wherein the score for the personality type comprises assessing the candidate's personality as one of a thoughts, opinions, reactions, or emotions type.

13. The method of claim 9, further comprising aggregating the scores for engagement, motivation, distress, and personality type into an overall interview score.

14. The method of claim 9, further comprising analyzing video of the job candidate including the verbal answers.

15. The method of claim 9, further comprising correlating the scores to direct feedback on the job candidate after being hired and/or on the job performance.

16. The method of claim 9, wherein the job candidate is remote from an interviewer.

17. A non-transitory computer readable article comprising a plurality of instructions comprising:
instructions, that when executed, present a plurality of interview questions to a job candidate;
instructions, that when executed, receive the job candidate's verbal answers to a the questions;
instructions, that when executed, score the job candidate's answers for a plurality of categories using at least one linguistic algorithm that scores the answers based on the density of keywords and that comprises a psychological behavioral model;
instructions, that when executed, aggregate the score for each category into an overall interview score; and
instructions, that when executed, display the overall interview score.

18. The non-transitory computer readable article of claim 17, wherein each category comprises one or more of engagement, motivation, distress, or personality type.

19. The non-transitory computer readable article of claim 18, wherein the score for engagement, motivation, and distress is each independently high, medium, or low.

20. The non-transitory computer readable article of claim 18, wherein the score for the personality type is an assessment that the candidate is one of a thoughts, opinions, reactions, or emotions type.

21. The non-transitory computer readable article of claim 17, wherein the linguistic algorithm identifies keywords associated with each category.

22. The non-transitory computer readable article of claim 17, further comprising instructions, that when executed, analyze video of the job candidate including at least the verbal answers.

23. An apparatus for evaluating job candidates, which comprises:
a storage device storing a computer readable program; and
a processor executing the computer readable program, the computer readable program comprising:
a display module configured to present a plurality of interview questions to job candidates and output a score for each job candidate.
a recording module configured to receive and record a plurality of verbal answers from the job candidates; and
a scoring module configured to:
receive identified keywords associated with predefined criteria for a position,
apply an algorithm based on a psychological behavioral model trained to find the number of times the keywords are used in the answers, and
score the answers for each job candidate using the trained algorithm.
